(19) United States
(12) Patent Application Publication
(10) Pub. No.: US 2017/0193605 A1
(43) Pub. Date: Jul. 6, 2017

(54) SYSTEM AND METHOD FOR INSURANCE CLAIM ASSESSMENT

(71) Applicant: Cognizant Technology Solutions India Pvt. Ltd., Chennai (IN)

(72) Inventors: Sanjay Narendran, Chennai (IN); Senthil Raja Sennimalai, Salem (IN); Bhuvaneswari Paramasivam, Erode (IN); Joseph Godfrey Nixon Homer, Chennai (IN)

(21) Appl. No.: 15/386,216

(22) Filed: Dec. 21, 2016

(30) Foreign Application Priority Data
Dec. 30, 2015 (IN) 7068/CHE/2015

(51) Int. Cl. G06Q 40/08; G06Q 10/06

(52) U.S. Cl. CPC G06Q 40/08; G06Q 10/0631

(57) ABSTRACT

A system and method for simultaneously processing multiple claim objects data from different locations is provided. Two or more insurance claims corresponding to multiple claim objects are received from different locations. Parameters related to insurance claims and multiple claim objects are determined. Capability information related to two or more claim inspection systems is assessed. Determined parameters and the capability assessment information are correlated with predefined rules. Based on the correlation, the received insurance claims is assigned to a different claim inspection system. From the claim inspection systems, a multimedia file representing captured information related to inspection of claim object of the assigned insurance claim is simultaneously received. The received multimedia files are simultaneously processed and transmitted to a claim assessment device for assessment of the multiple claim objects. The claim assessment device is placed at a second location which is different from the location of the claim inspection systems.

### FIELD OF THE INVENTION

The present invention relates generally to the field of insurance claim assessment. In particular, the present invention relates to a method and system for conducting inspection and assessment of damages to an insured property simultaneously at different locations by utilizing two or more electronic devices.

### BACKGROUND OF THE INVENTION

In an insurance claim process, an owner of a damaged property initiates claim submission of the property with the insurance organization. The insurance organization then validates the claim and assigns the claim to a claim handling personnel. The claim handling personnel then conducts inspection of the damaged property, assesses the loss to the property for preparing a compensation plan for the owner of the damaged property, and finally a settlement is made. The above claim processes were traditionally handled manually including the assigning, inspection assessment, and the settlement phases of the insurance claim.

With the advent of smart phones, tablets, and insurance specific software applications, the involvement of technology in the claim inspection and assessment processes has been enhanced to a certain extent. Currently, the insurance organizations generally handover aforementioned devices to trained insurance personnel who personally visit the location of the damaged property, and prepare an assessment report for compensation using the smart phones and tablets.

The technological advancements in the insurance domain have aided a smooth claim settlement, however, even with the utilization of aforementioned devices, the costs incurred by the insurance organizations for claim assessment processes have not been reduced. A significant cost is borne by the insurance organizations as a payout in travel and hospitality of trained insurance personnel involved in inspection of damaged properties and assessment of claims. In addition to the higher costs, the insurance organizations continue to suffer from shortage of trained insurance personnel for inspection and assessment processes. Moreover, the utilized smart phones and tablets do not assist the trained personnel during mass catastrophe damage, or in cases where assessments have to be carried out in highly hazardous locations.

In light of the above, there is a need for an efficient system and method for minimizing the costs incurred by insurance organizations during inspection and claim assessment processes. Further, there is a need for automated and proficient systems to address the shortage of trained personnel. In addition, there is a need for advanced systems which may be utilized in case of inspection at hazardous remote locations.

### SUMMARY OF THE INVENTION

In various embodiments of the present invention, a centralized server for simultaneously processing data associated with multiple claim objects at different locations is provided. The centralized server comprises a memory comprising program instructions. The centralized server further comprises a processor configured to execute program instructions stored in the memory. Further, the centralized server comprises an input unit in communication with the processor and configured to receive two or more insurance claims from user devices corresponding to the multiple claim objects placed at different locations. The centralized server further comprises an analyzing unit in communication with the processor and configured to determine one or more parameters related to the insurance claims and the multiple claim objects. Furthermore, the analyzing unit is configured to assess capability information related to two or more claim inspection systems. The centralized server further comprises a task allotment unit in communication with the processor and configured to correlate the determined one or more parameters and the capability assessment information with one or more predefined rules stored in a repository, and assign, based on the correlation, each of the received insurance claims to a different claim inspection system of the two or more claim inspection systems. Furthermore, the centralized server comprises a multimedia stream processing unit in communication with the processor and configured to simultaneously receive, from each of the two or more claim inspection systems, a multimedia file representing captured information related to inspection of the claim object associated with the assigned insurance claim. The centralized server simultaneously processes and transmits the received multimedia files to a claim assessment device for assessment of each of the multiple claim objects associated with the insurance claims. The claim assessment device is placed at a second location and the second location is different from the location of each of the claim inspection systems.

In various embodiments of the present invention, an electronic communications device for simultaneously assessing data associated with multiple claim objects at different locations is provided. The electronic communication device comprises a memory comprising program instructions and a processor configured to execute program instructions stored in the memory. The electronic communications device is configured to receive two or more multimedia files. Each of the two or more multimedia files represent captured information related to inspection of each of the multiple claim objects. The multiple claim objects are placed at different locations. Each multimedia file comprises a real-time first view video of each of the multiple claim objects. The electronic communications device is further configured to simultaneously display the real-time first view video corresponding to each of the two or more multimedia files, and generate an insurance claim assessment report corresponding to each of the two or more multimedia files based on assessment of each of the multiple claim objects.

In various embodiments of the present invention, a method for simultaneously processing data associated with multiple claim objects at different locations is provided. The method comprises receiving two or more insurance claims from user devices corresponding to the multiple claim objects placed at different locations. The method further comprises determining one or more parameters related to the insurance claims and the multiple claim objects. Furthermore, the method comprises assessing capabilities of two or more claim inspection systems. The method comprises correlating the determined one or more parameters and the capability assessment information with one or more predefined rules. Furthermore, the method comprises assigning, based on the correlation, each of the received insurance claims to a different claim inspection system of the two or more claim inspection systems. Further, the method comprises simultaneously receiving a multimedia file representing captured information related to inspection of the claim object associated with the assigned insurance claim. Finally, the method comprises simultaneously processing and transmitting the received multimedia files for assessment of each of the multiple claim objects associated with the insurance claims. The assessment is performed at a second location. The second location is different from the location of the multiple claim objects.

In various embodiments of the present invention, a method for simultaneously assessing data associated with multiple claim objects placed at different locations is provided. The method comprises receiving two or more multimedia files. Each of the two or more multimedia files represent captured information related to inspection of each of the multiple claim objects. The multiple claim objects are placed at different locations, and wherein each multimedia file comprises a real-time first view video of each of the multiple claim objects. Further, the method comprises simultaneously displaying the real-time first view video corresponding to each of the two or more multimedia files. Finally, the method comprises generating an insurance claim assessment report corresponding to each of the two or more multimedia files based on assessment of each of the multiple claim objects.

### BRIEF DESCRIPTION OF THE DRAWINGS

The present invention is described by way of embodiments illustrated in the accompanying drawings wherein:

FIG. 1 is a block diagram of a system for assessment and inspection of damages in insurance claims settlement, in accordance with various embodiments of the present invention;

FIG. 2 is a block diagram of a claim inspection system for inspection of a claim object at its location, in accordance with an embodiment of the present invention;

FIG. 3 is a block diagram of a centralized server, in accordance with an embodiment of the present invention;

FIG. 4 illustrates a flowchart of a method for inspection and assessment of damages in a claim object at a centralized server, in accordance with various embodiments of the present invention;

FIG. 5 illustrates a flowchart for inspection at the claim object location via a claim inspection system, in accordance with an embodiment of the present invention;

FIGS. 6A and 6B illustrate a flowchart for assessment of damages of the claim object at the assessment device location different from the location of the claim object, in accordance with an embodiment of the present invention;

FIG. 7 illustrates an exemplary user interface of the claim assessment device during multimedia conference session with the claim inspection systems, in accordance with an embodiment of the present invention;

FIG. 8 illustrates another exemplary user interface of the claim assessment device during multimedia conference session with the claim inspection systems, in accordance with an embodiment of the present invention; and

FIG. 9 illustrates a computer system in which various embodiments of the present invention may be implemented.

### DETAILED DESCRIPTION OF THE DRAWINGS

A system and method for conducting inspection of a damaged property and assessment of losses to the property incurred during insurance claim processing is provided. The inspection and assessment are conducted simultaneously at two different locations by utilizing two or more electronic devices. The invention particularly provides for receiving, at an assessment device, real-time multimedia streams (e.g. audio, video, etc.) corresponding to inspection of damaged properties at different locations, each of the multimedia streams being captured via at least one of a wearable electronic device and an unmanned aerial vehicle. Further, the invention provides for an optimized user interface for managing real-time interactions between a highly skilled insurance personnel at the assessment device location and each of a novice or third-party inspection personnel at the different damaged properties locations.

Throughout the specification, the terms “insured property”, “damaged property” and “claim object” along with their corresponding semantic variants are used interchangeably. Further, throughout this specification, the term “inspection” refers to investigation phase of an insurance claim settlement process, where an insured property or a claim object is examined before settlement of the insurance claim. The “inspection” is performed using a claim inspection system (as discussed hereinafter) by personnel who may be novice or ordinarily skilled to the insurance claim assessment process. Furthermore, the term “assessment” refers to a more detailed evaluation of the damaged property by a trained insurance personnel and determining the total loss incurred based on the damage to the insured property. The present invention generally relates to the “inspection” and “assessment” phases in an insurance claim settlement process.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

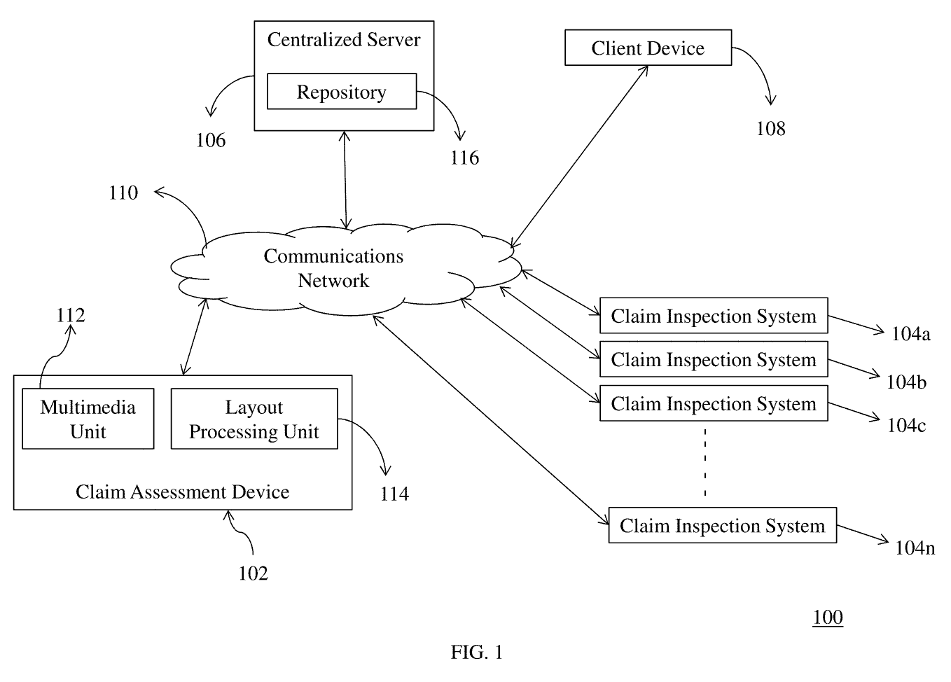

FIG. 1 is a block diagram of a system 100 for inspection and assessment of damaged properties in insurance claim processes, in accordance with various embodiments of the present invention. Insurance claim includes, but is not limited to, car insurance claim, residential property insurance claim, commercial property insurance claim etc. In various embodiments of the present invention, the system 100 is implemented in a client-server architecture. The system 100 comprises a claim assessment device 102, claim inspection systems 104a-104n, a centralized server 106 and a client device 108.

The claim assessment device 102 is an electronic communications device which is configured for carrying out multimedia communications (i.e. audio, video, text and data communication) with other electronic communications devices over a communications network 110. Examples of the claim assessment device 102 include, but are not limited to, personal computer (PC), smartphones, tablet phones such as iPads, and other wireless communications devices. The communications network 110 includes, but is not limited to, Wireless Fidelity (Wi-Fi) networks, Third Generation (3G) networks, 3.5G networks, Fourth Generation or Long Term Evolution networks (4G/LTE), and high speed networks supporting multimedia communications services. The claim assessment device 102 communicates with the claim inspection systems 104a-104n, centralized server 106, and the client device 108 over the communications network 108.

In an embodiment of the present invention, the claim assessment device 102 comprises a multimedia unit 112 and a layout processing unit 114. The multimedia unit 112 is configured to initiate and participate in a multimedia communication session such as a multiparty conference session. The multimedia unit 112 is further configured to process individual multimedia streams received from claim inspection systems 104a-104n for displaying each of the individual multimedia streams. The claim assessment device 102 is placed at a location different from locations of each of the claim inspection systems 104a-104n. In an exemplary embodiment of the present invention, the multimedia unit 112 may comprise a video codec such as Advanced Video Coding H.264 AVC codec or an ITU-T Rec. H.264's Scalable Video Codec (SVC) codec to perform coding and decoding of the multimedia streams. The multimedia unit 112 may also comprise an audio codec, such as Adaptive Multi-Rate codec (AMR) or AMR Wideband codec (AMR-WB), or Advanced Audio Coding codec (AAC). The layout processing unit 114 is configured to display each of the individual multimedia stream based on a predefined layout pattern. The multimedia unit 112 and the layout processing unit 114 execute various functionalities via one or more processors (not shown) using program instructions stored in a memory (not shown). The operations of the multimedia unit 112 and the layout processing unit 114 will be explained in detail in later sections of the specification.

In an embodiment of the present invention, the claim inspection systems 104a-104n are employed for simultaneously inspecting claim objects which are at different locations. In particular, each of the claim inspection systems 104a-104n is employed for inspection of a different claim object at the location of the claim object. Further, each of the claim inspection systems 104a-104n is configured for capturing a first view video of the claim object at its location via one or more electronic devices (not shown in FIG. 1). Examples of electronic devices for capturing the first view video may include, but not limited to, a wearable electronic device and an unmanned aerial vehicle. The “first view video” is a virtual view of the claim object and is captured by at least one of a wearable electronic device and an unmanned aerial vehicle at the location of the claim object. In another embodiment of the present invention, the claim inspection systems 104a-104n may be configured to capture one or more details of the claim object in accordance with one or more instructions received from the claim assessment device 102. The one or more instructions may be received in the form of a checklist including multiple tasks to be performed for claim inspection by the claim inspection systems 104a-104n. For example, the claim inspection system 104a may receive an instruction from the claim assessment device 102 to capture a front view and a back view of the claim object. In another exemplary embodiment of the present invention, a claim inspection system 104a-104n may receive an instruction from the claim assessment device 102 for conducting inspection of an insurance claim object by capturing a first view using a device associated with the claim inspection system, and capturing a second view using another device associated with the claim inspection system.

Further, each of the claim inspection systems 104a-104n is configured to initiate and/or participate in a multimedia conference session with the claim assessment device 102. The claim inspection systems 104a-104n transmit the first view video as a multimedia stream to the claim assessment device 102 during the multimedia conference session. Additionally, the claim inspection systems 104a-104n are configured to transmit one or more details corresponding to the claim object as requested by the claim assessment device 102. Further, during the multimedia conference session, each of the claim inspection systems 104a-104n is configured to receive a multimedia stream from the claim assessment device 102 in real-time. The multimedia stream comprises audio, image, video etc. The claim inspection systems 104a-104n are explained in detail in later sections of the specification.

In an embodiment of the present invention, the client device 108 is a communication device held by the owner of insured property. The client device 108 is configured to transmit a new insurance claim corresponding to damages incurred to the insured property. Examples of the client device 108 includes, but are not limited to, personal computer (PC), smartphones, tablet phones such as iPads, and other wireless communications devices.

The centralized server 106 is configured to receive a new insurance claim from the client device 108 and assign the received insurance claim to a claim inspection system 104a-104n for inspection and assessment of the damaged property. For example, the received insurance claim may be assigned to the claim inspection system 104a for inspection of the claim object for assessment of the loss to the claim object. For assignment of the insurance claim to one of the claim inspection systems 104a-104n, the centralized server 106 may determine one or more parameters related to the insurance claim and the claim object. The one or more parameters may comprise a challenging level, track record of user associated with the claim object, etc. In an embodiment of the present invention, the challenging level may be higher for a building than a car. The track record of the user associated with the claim object may be determined based on number of claims raised by the user associated with the claim object. Further, the centralized server 106 assesses capability information related to the claim inspection systems 104a-104n. The capability information may be assessed based on quality of devices in the claim inspection systems 104a-104n, skills of personnel associated with the claim inspection systems 104a-104n, etc. Furthermore, the centralized server 106 correlates the determined one or more parameters and the capability assessment data with one or more predefined rules stored in the repository 116. In an embodiment of the present invention, the repository 116 may be included within the centralized server 106. In another embodiment of the present invention, the repository 116 may be located outside the centralized server 106, and in communication with the centralized server 106. The one or more predefined rules may include, but are not limited to, type of the insurance claim, skill and experience of the personnel, specifications of the claim inspection systems, etc. The assignment of the insurance claim to one of the claim inspection systems 104a-104n may be based on the correlation. Additionally, the insurance claim may be assigned to the claim assessment device 102 for assessment of the insurance claim inspection. Although, the system 100 includes one claim assessment device 102, it may be understood that the system 100 may include multiple claim assessment devices. In the scenario of the system 100 comprising multiple claim assessment devices, the centralized server 106 may perform one or more above discussed analysis steps (similar to the steps for claim inspection systems 104a-104n) and assign the insurance claim to one of the multiple claim assessment devices. In an embodiment of the present invention, the assignment of the received insurance claim to any one of the claim inspection systems 104a-104n is performed via a claim processing system (not shown). The claim processing system may be in communication with the centralized server 106. Examples of claim processing system may include, an insurance platform product such as, but not limited to, Guidewire. The claim processing system has pre-configured set of modules and rules for assigning a received insurance claim to the claim inspection system 104a as well as to the claim assessment device 102. In another embodiment of the present invention, the received claim is initially assigned to the claim assessment device 102. The claim may then be assigned by a user associated with the claim assessment device 102 to one of the claim inspection systems 104a-104n for inspection at the claim object site. The assignment of the claim may be based on a crowdsourcing model, i.e., a claim may be assigned to third-party claim inspection systems 104a-104n.

In another embodiment of the present invention, the centralized server 106 is configured to mediate end-to-end multimedia communications between the claim assessment device 102 and each of the claim inspection systems 104a-104n. In particular, the centralized server 106 is configured to facilitate multimedia communications sessions between the claim assessment device 102 and each of the claim inspection systems 104a-104n during inspection of the claimed objects at the claim object locations. In an exemplary embodiment of the present invention, the centralized server 106 may be deployed in a cloud computing architecture. In another exemplary embodiment of the present invention, the centralized server 106 may be deployed in data centers of telecommunication service providers of multimedia services. In yet another exemplary embodiment of the present invention, the centralized server 106 may be dispersed across both the cloud and the data centers. The centralized server 106 execute various functionalities via one or more processors (not shown) using program instructions stored in a memory (not shown).

In an exemplary embodiment of the present invention, the centralized server 106 processes individual multimedia streams received from the claim assessment device 102 and the claim inspection systems 104a-104n for routing the streams to the appropriate destinations. For example, the centralized server 106 is configured to transmit each of the processed individual multimedia streams received from the claim inspection systems 104a-104n to the claim assessment device 102 during a multiparty conference session. Further, the centralized server 106 processes the individual multimedia streams by dynamically adapting the bitrates of the individual media streams based on the capability of the destination device and communications network 110 conditions. The centralized server 106 executes various functionalities via one or more processors (not shown) using program instructions stored in a memory (not shown). The operations of the centralized server 106 will be discussed in detail in later sections of the specification.

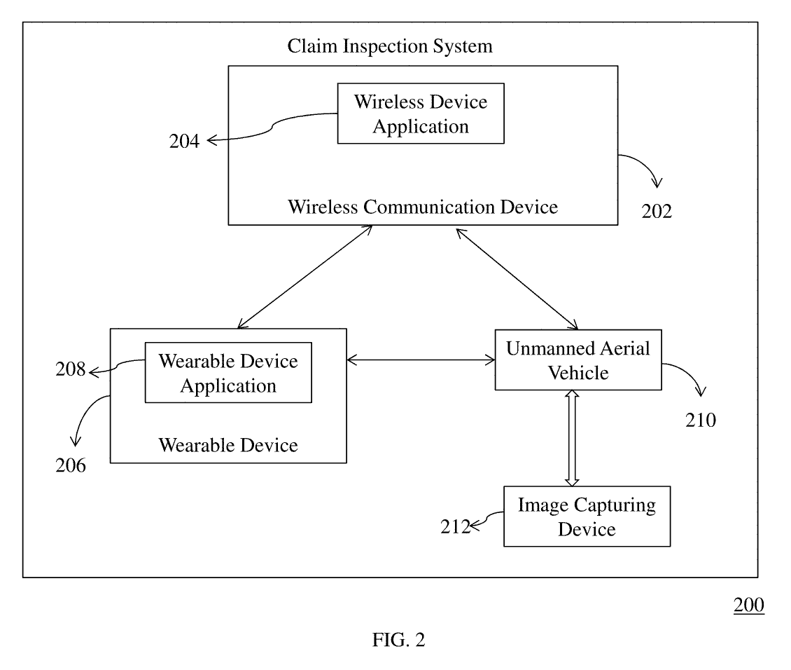

FIG. 2 is a block diagram of a claim inspection system 200 for inspection of a claim object at its location, in accordance with an embodiment of the present invention.

The claim inspection system 200 comprises a wireless communication device 202, a wearable device 206, an unmanned aerial vehicle 210, and an image capturing device 212.

In an embodiment of the present invention, the wireless communication device 202 is configured to communicate with the wearable device 206 and the unmanned aerial vehicle 210. In an exemplary embodiment of the present invention, the wireless communication device 202 creates a wireless internet hotspot. The wearable device 206 and the unmanned aerial vehicle 210 use the wireless internet hotspot to communicate with each other. In another exemplary embodiment of the present invention, the unmanned aerial vehicle 210 creates a wireless internet hotspot, thus providing a communication channel, so that the devices of the claim inspection system may communicate with each other.

Further, the wireless communication device 202 communicates with the claim assessment device 102 (FIG. 1) via the centralized server 106 (FIG. 1) over the communications network 110 (FIG. 1). The wireless communication device is further configured to include a wireless device application 204. In an exemplary embodiment of the present invention, the wireless device application 204 may be a software application installed at the wireless communication device 202 which is configured to provide an interface for communication between the wireless communication device 202 and the wearable image capturing device 206 as well as the unmanned aerial vehicle 210.

In an embodiment of the present invention, the wireless communication device 202 receive an assigned insurance claim from the centralized server 106 (FIG. 1). The details of the assigned insurance claim are displayed at a user interface of the wireless device application 204 for initiating the inspection of the claim object. The details displayed at the user interface may include, but are not limited to, location of claim object, a checklist comprising a set of activities to be performed during inspection of the claim object, etc. The details of the assigned insurance claim are then transmitted to the wearable device 206. In an exemplary embodiment of the present invention, wearable device 206 receives the details of assigned insurance claim directly from the centralized server 106 (FIG. 1).

In an embodiment of the present invention, the wearable device 206 is configured to perform the inspection by capturing a first view video of the claim object corresponding to the assigned insurance claim. Examples of the wearable device 206 may include, but are not limited to, a head mounted electronic device, an electronic device worn as a pair of glasses (e.g. GOOGLE GLASS®), a smart watch, etc.

In an embodiment of the present invention, the wearable device 206 includes a wearable device application 208 which is in communication with the wireless communication device 202 for providing control of the wearable device 206 at the wireless communication device 202. In another embodiment of the present invention, the wearable device 206 may be controlled via one or more controls (e.g. one or more keys or buttons) provided at the wearable device 206 in communication with the wearable device application 208. The wearable device application 208 may be a software application installed at the wearable device 206 which is configured to enable one or more functionalities at the wearable device 206. The functionalities enabled by the wearable device application 208 may include displaying insurance claim details at the wearable device 206. Further, the wearable device application 208 may be configured to perform one or more actions (e.g. initiate capturing of a video) in response to a gesture or voice command received at the wearable device 206. Additionally, the wearable device application 208 may be configured to initiate a multimedia conference session with the claim assessment device 102 (FIG. 1) for transmitting the first view video, audio, image, text, etc. corresponding to inspection of the claim object to the claim assessment device 102.

In an exemplary embodiment of the present invention, the novice personnel associated with the claim inspection system 200 may wear a GOOGLE GLASS® which is configured to display one or more details related to the assigned insurance claim through the glasses while at least some portions of the surrounding environment may be simultaneously viewed. In another exemplary embodiment of the present invention, the wearable device 206 may be configured to automatically select one insurance claim of multiple insurance claims received for inspection based on a predefined set of rules stored in a data store (not shown). The data store is included within the wearable device 206. Further, the predefined set of rules may include, the type of insurance claim, the skill set of the novice personnel wearing the wearable image capturing device for inspection, etc. The wearable device 206 (i.e. GOOGLE GLASS®) may initiate capturing first view video and other details (in accordance with instructions received from the claim assessment device 102) of the claim object and simultaneously initiate a real-time multimedia session with the claim assessment device 102 (FIG. 1) for interacting with a trained insurance personnel at the claim assessment device 102. The first view video and the other captured details are transmitted as a multimedia stream to the claim assessment device 102 during the multimedia session.

In another embodiment of the present invention, the wearable device application 208 may be configured to communicate with the unmanned aerial vehicle 210. Examples of the unmanned aerial vehicle 210 may include, a drone, etc. In particular, the unmanned aerial vehicle may be controlled via the interface of wearable device application 208. In another embodiment of the present invention, the wearable device application 208 may be configured to control one or more functionalities of the unmanned aerial vehicle 210 via voice commands, gestures, etc. inputted by the user of the wearable device 206.

In an embodiment of the present invention, the unmanned aerial vehicle 210 in combination with the image capturing device 212 is employed for inspecting the claim object especially at hazardous/unreachable locations. The image capturing device 212 captures the first view video of the claim object and transmits the same to the claim assessment device 102 (FIG. 1), the wireless communication device 202 and the wearable device 206 during the multimedia session. In an exemplary embodiment of the present invention, the image capturing device 212 may be integrated within the unmanned aerial vehicle 210.

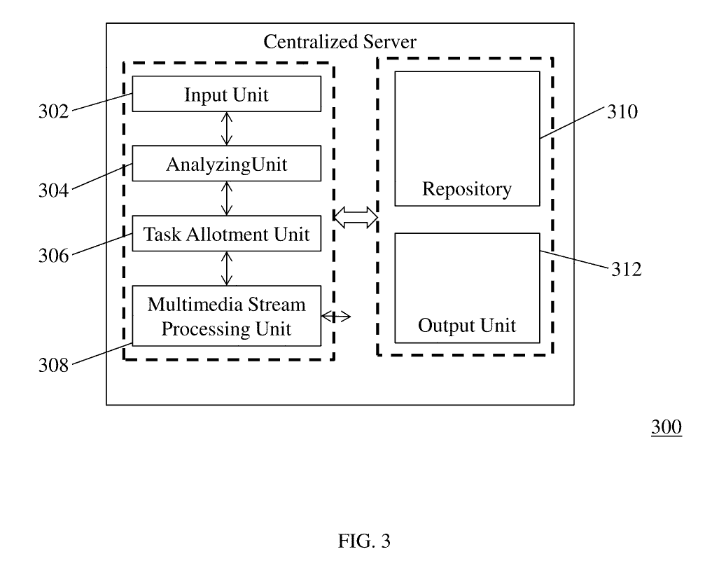

FIG. 3 is a block diagram of a centralized server, in accordance with an embodiment of the present invention.

The centralized server 300 comprises an input unit 302, a processing unit 304, a task allotment unit 306, a multimedia processing unit 308, a repository 310, and an output unit 312.

In an embodiment of the present invention, the input unit 302 is configured to receive an insurance claim request from an owner of an insured property via a client device (FIG. 1) of the owner. The received insurance claim request may comprise one or more parameters related to the corresponding insurance policy contract for verification at the centralized server 300. Further, the input unit 302 is configured to receive a multimedia stream corresponding to the inspection of the claim object. The multimedia stream is received from a claim inspection system (104a-104n of FIG. 1) in real-time during the inspection of the claim object.

The analyzing unit 304 is configured to verify the authenticity and analyze the received insurance claim request. In an embodiment of the present invention, the identity of the client device (FIG. 1) (from which the insurance claim request is received) is verified for authenticating the insurance claim request. The client device (FIG. 1) identity may have been included in the insurance policy contract for the claim object, which may be stored in the repository 310. In an embodiment of the present invention, the repository 310 may be included within the centralized server 300. In another embodiment of the present invention, the repository 310 may be located outside the server 300, and in communication with the centralized server 300. The analyzing unit 304 may further determine one or more parameters related to the insurance claim and the claim object. The one or more parameters may comprise a challenging level, track record of user associated with the claim object, etc. In an embodiment of the present invention, the challenging level may be higher for a building than a car. The track record of the user associated with the claim object may be determined based on number of claims raised by the user associated with the claim object. Further, the analyzing unit 304 assesses capability information related to the claim inspection systems 104a-104n (shown in FIG. 1). The capability information may be assessed based on quality of devices in the claim inspection systems 104a-104n, skills of personnel associated with the claim inspection systems 104a-104n, etc.

The task allotment unit 306 is configured to assign the claim to one or more claim inspection system 104a-104n (FIG. 1). For assignment of the insurance claim to one of the claim inspection systems 104a-104n (FIG. 1), the task allotment unit 306 correlates the determined one or more parameters and the capability assessment data to one or more predefined rules stored in the repository 310. The one or more predefined rules may include, but are not limited to, type of the insurance claim, skill and experience of the personnel, specifications of the claim inspection systems, etc. In an embodiment of the present invention, the allotment of the received insurance claim request may include determining a type of insurance policy contract based on the details of the received request. Further, the allotment process may include determining a level of skill required for inspection and assessment of the received insurance claim. In an embodiment of the present invention, the details of the personnel along with their skill and experience data may be stored at the repository 310. In an embodiment of the present invention, the assignment of the received insurance claim to anyone of the claim inspection systems 104a-104n (FIG. 1) is performed via a claim processing system (not shown). Examples of claim processing system may include, an insurance platform product such as, but not limited to, Guidewire®. The claim processing system has pre-configured set of modules and rules for assigning a received insurance claim to the claim inspection system 104a (FIG. 1) as well as the claim assessment device 102 (FIG. 1).

The multimedia stream processing unit 308 is configured to simultaneously receive one or more multimedia streams from claim inspection systems 104a-104n (FIG. 1) and transmit the streams simultaneously to the claim assessment device 102 (FIG. 1) for establishing a real-time multimedia conference between the claim assessment device 102 (FIG. 1) and the claim inspection system (e.g. 104a as shown in FIG. 1) for further assessment. Further, in an embodiment of the present invention, the multimedia stream processing unit 308 may be configured to process the individual stream by dynamically adapting the bitrates of the individual media streams based on the destination device and communications network 110 conditions.

In an embodiment of the present invention, the output unit 312 is configured to transmit the one or more details related to the insurance claim inspection and assessment to the claim assessment device 102 (FIG. 1) and the claim inspection system (e.g. 104a as shown in FIG. 1) respectively. The one or more details may include, but are not limited to, one or more predefined set of rules (e.g. a checklist) for performing at least one activity for the claim inspection and assessment process. For example, the one or more predefined set of rules may include guidelines for taking pictures of the claim object, minimum specification of the devices for performing the inspection and assessment, etc. Further, the output module 312 is configured to transmit/route multimedia stream to appropriate destinations (e.g. claim assessment device 102).

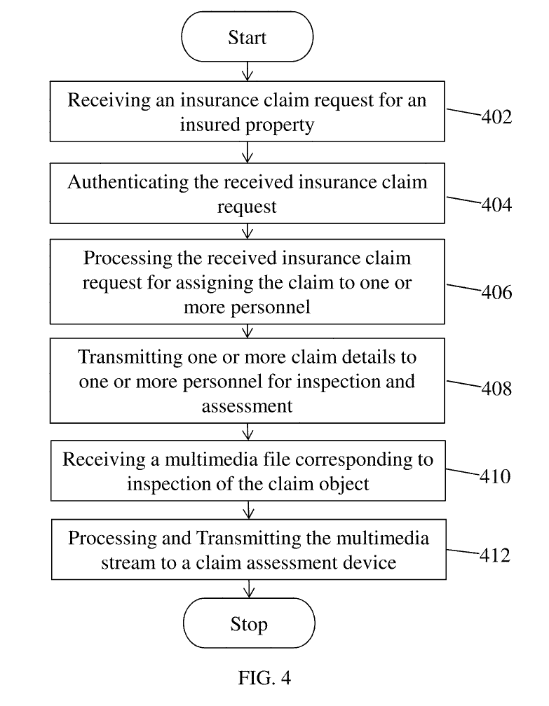

FIG. 4 illustrates a flowchart of a method for inspection and assessment of damages in a claim object at a centralized server, in accordance with various embodiments of the present invention.

At step 402, an insurance claim request is received from an owner of an insured property via a client device of the owner. As is well known in the art, the insurance claim request is raised by the owner of an insured property against an insurance policy contract with an insurance company, which is not explained herein. In an embodiment of the present invention, the received insurance claim request may comprise one or more parameters related to the insurance policy contract for verification at the centralized server. In another embodiment of the present invention, the owner's client device identity may itself be registered at the centralized server, which may be verified for authenticity of the insurance claim request.

At step 404, the received insurance claim request is verified for authenticity of the claim request. In an embodiment of the present invention, the identity of the client device (from which the insurance claim request is received) is verified for authenticating the insurance claim request. The client device identity may have been included in the insurance policy contract for the claim object, which may be stored in a repository at the centralized server. Alternatively, the centralized server may communicate with an external insurance company's server for details of the insurance policy contract in order to authenticate the insurance claim request. In an exemplary embodiment of the present invention, one or more other details such as, but not limited to, expiry of insurance policy date may be verified for authenticating the received insurance claim request.

At step 406, the received insurance claim request is processed for assigning the claim to one of the claim inspection system 104a-104n. In an embodiment of the present invention, for processing and assigning the insurance claim to one of the claim inspection systems 104a-104n belonging to one or more personnel, one or more parameters related to the insurance claim and the claim object may be determined. The one or more parameters may comprise a challenging level, track record of user associated with the claim object, etc. In an embodiment of the present invention, the challenging level may be higher for a building than a car. The track record of the user associated with the claim object may be determined based on number of claims raised by the user associated with the claim object. Further, capability information related to the claim inspection systems 104a-104n (FIG. 1) may be assessed. The capability information may be assessed based on quality of devices in the claim inspection systems 104a-104n (FIG. 1), skills of personnel associated with the claim inspection systems 104a-104n (FIG. 1), etc. Furthermore, the determined one or more parameters and the capability assessment data are then correlated to one or more predefined rules. The one or more predefined rules may include, but are not limited to, type of the insurance claim, skill and experience of the personnel, specifications of the claim inspection systems, etc. The assignment of the insurance claim to one of the claim inspection systems 104a-104n may be based on the correlation. In another embodiment of the present invention, the processing of the received insurance claim request may include determining a type of insurance policy contract based on the details of the received request. Further, the processing may include determining a level of skill required for inspection and assessment of the received insurance claim.

In an embodiment of the present invention, the insurance claim may be assigned to one of the claim inspection systems (104a-104n of FIG. 1) associated with one or more personnel based on the processed details. In an exemplary embodiment of the present invention, the personnel may be categorized into two different types including, a trained insurance personnel for assessment and a novice insurance personnel for inspection at the claim object location. The trained personnel may perform the assessment via the claim assessment device, based on a real-time multimedia conference with the novice insurance personnel. The novice personnel, for example, may be a resident in the vicinity of the claim object who performs the inspection via the claims inspection system (104a-104n of FIG. 1). Alternatively, the novice personnel may be a third-party personnel or a freelancer who is not associated with the insurance organization carrying out the inspection at the claim object location under the guidance of the trained insurance personnel.

At step 408, one or more details related to the insurance claim inspection and assessment are transmitted to the claim assessment device and the claim inspection system of the assigned personnel. In an embodiment of the present invention, the one or more details may include, but are not limited to, one or more predefined set of rules (e.g. a checklist) for performing at least one activity for the claim inspection and assessment process. For example, the one or more predefined set of rules may include guidelines for taking pictures of the claim object, minimum specification of the devices for performing the inspection and assessment, etc.

At step 410, a multimedia stream corresponding to the inspection of the claim object is received at the centralized server. In an embodiment of the present invention, the multimedia stream is received from a claim inspection system in real-time during the inspection of the claim object. Further, one or more other files, e.g., a text file, a voice note, etc. may be received along with the multimedia stream.

At step 412, the received multimedia stream is processed at the centralized server, and transmitted to the appropriate claim assessment device for establishing a real-time multimedia conference between the claim assessment device and the claim inspection system for further assessment. In an embodiment of the present invention, the received multimedia stream may include an identifier corresponding to the claim inspection system based on which the multimedia stream may be identified and transmitted to the claim assessment device. Further, the individual multimedia streams may be processed by dynamically adapting the bitrates of the individual media streams based on the destination device and communications network 110 conditions.

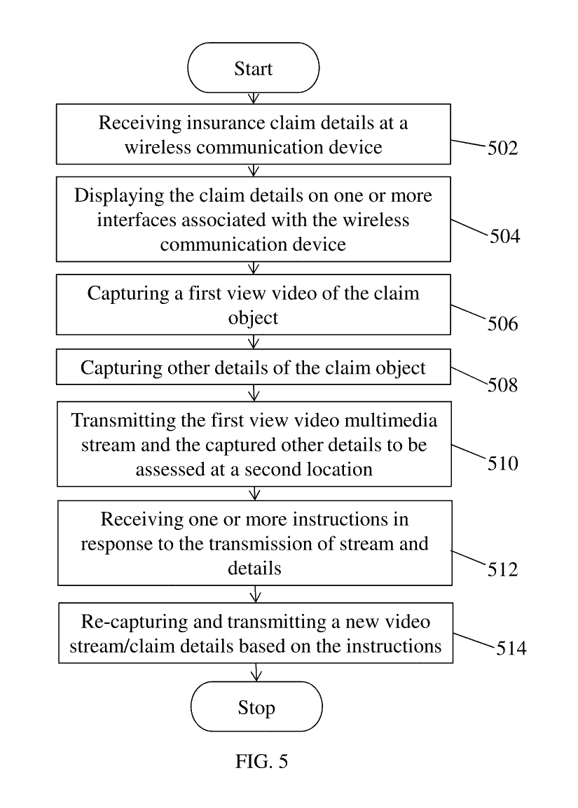

FIG. 5 illustrates a flowchart for inspection at the claim object location via a claim inspection system, in accordance with an embodiment of the present invention.

At step 502, one or more details related to the insurance claim inspection are received at the wireless communication device of the claim inspection system. In an embodiment of the present invention, the one or more details may include, but not limited to, a claim number, one or more predefined set of rules for performing the claim inspection at the claim object location, etc. For example, the one or more predefined set of rules may include guidelines for taking pictures of the claim object, minimum specification of the devices for performing the inspection and assessment, etc.

At 504, the received claim details are displayed at one or more user interfaces associated with the wireless communication device of the claim inspection system. In an embodiment of the present invention, the received details are displayed at the user interface of the wireless communication device as well as at an interface of the wearable device, which is in communication with the wireless communication device. In an exemplary embodiment of the present invention, the received details may be displayed at a GOOGLE GLASS® device interface for capturing a first view video of the claim object.

At step 506, a first view video of the claim object is captured via one or more devices in communication with the wireless communication device of the claim inspection system. In an embodiment of the present invention, the first view video is captured via at least one of a wearable device and an unmanned air vehicle in communication with the wireless communication device of the claim inspection system. The “first view video” is a virtual view of the claimed object and is captured by a wearable electronic device or an unmanned aerial vehicle at the location of the claim object.

At step 508, one or more other details of the claim object are captured via the claim inspection system. In an embodiment of the present invention, the captured one or more other details may be included in form of, but not limited to, a text file, a voice note, and at least one other multimedia file, as requested in the one or more details related to the insurance claim inspection. In an exemplary embodiment, the captured one or more other details may include pictures of the claim object captured for a specified view (e.g., top view, front view, etc.) of the claim object. In another exemplary embodiment of the present invention, the captured one or more other details may include a voice note of the novice personnel who is involved in inspection of the claim object. The voice note may correspond to viewpoint of novice with respect to a particular aspect of inspection, for example, his view point with respect to a specific view or damage of the claim object.

At step 510, the multimedia stream along with the captured other details is transmitted to the claim assessment device. In an embodiment of the present invention, a multimedia conference session is initiated for transmission of the multimedia stream to the claim assessment device. The claim assessment device is at a location different from claim object location.

At step 512, one or more instructions for capturing at least one more video or detail is received at the wireless communication device of the claim inspection system. In an embodiment of the present invention, the one or more instructions are received in response to the multimedia stream and one or more other details transmitted from the claim inspection system.

At step 514, a new video or at least one other detail is captured based on the received one or more instructions. In an embodiment of the present invention, the new video or the at least one other detail is transmitted to the claim assessment device.

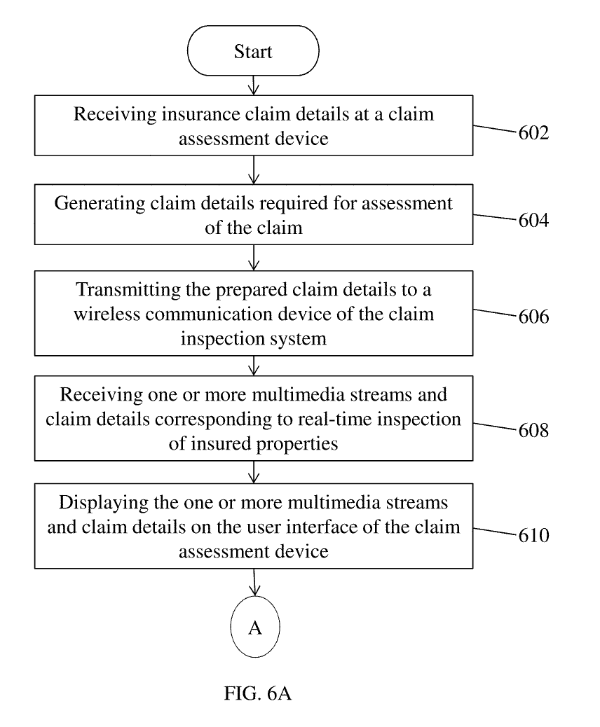

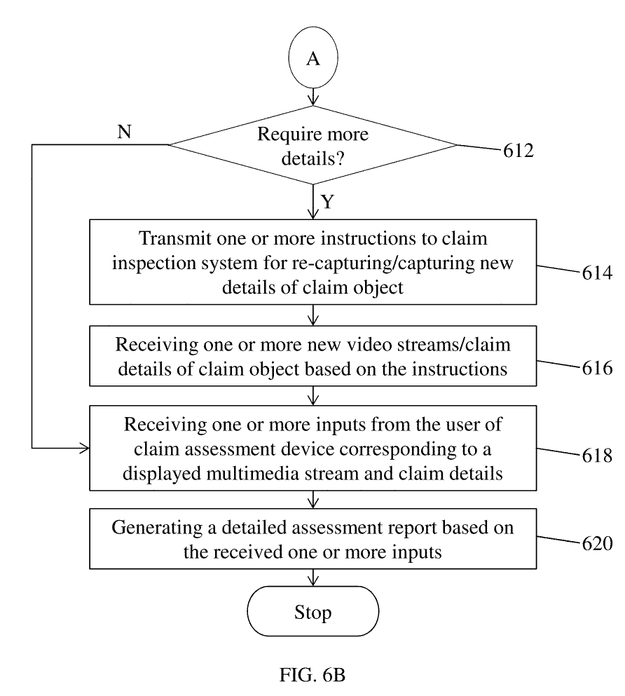

FIGS. 6A and 6B illustrate a flowchart for assessment of damages of the claim object at the assessment device location, different from the location of the claim object, in accordance with an embodiment of the present invention.

At step 602, one or more details related to the insurance claim assessment are received at the claim assessment device from the centralized server. Examples of the claim assessment device include, but are not limited to, personal computer (PC), smartphones, tablet phones such as iPads, and other wireless communications devices. In an embodiment of the present invention, the one or more details may include, but not limited to, one or more predefined set of rules for performing the claim assessment at the claim object location. For example, the one or more predefined set of rules may include guidelines for minimum details required for assessment of the claim object, one or more rules for determining compensation plan for the damage of the claim object, etc.

At step 604, one or more claim details (e.g. a checklist) is generated. In an embodiment of the present invention, the one or more claim details are generated based on the received one or more claim assessment details from the centralized server. In another embodiment of the present invention, the generation of one or more claim details may be further based on one or more inputs received from a highly skilled insurance personnel using the claim assessment device.

At step 606, the generated one or more claim details are transmitted to the wireless communication device of the claim inspection system.

At step 608, one or more multimedia streams and one or more other captured details are received corresponding to each of the claim inspection systems. In an embodiment of the present invention, each multimedia stream corresponds to real-time inspection at the location of a claim object.

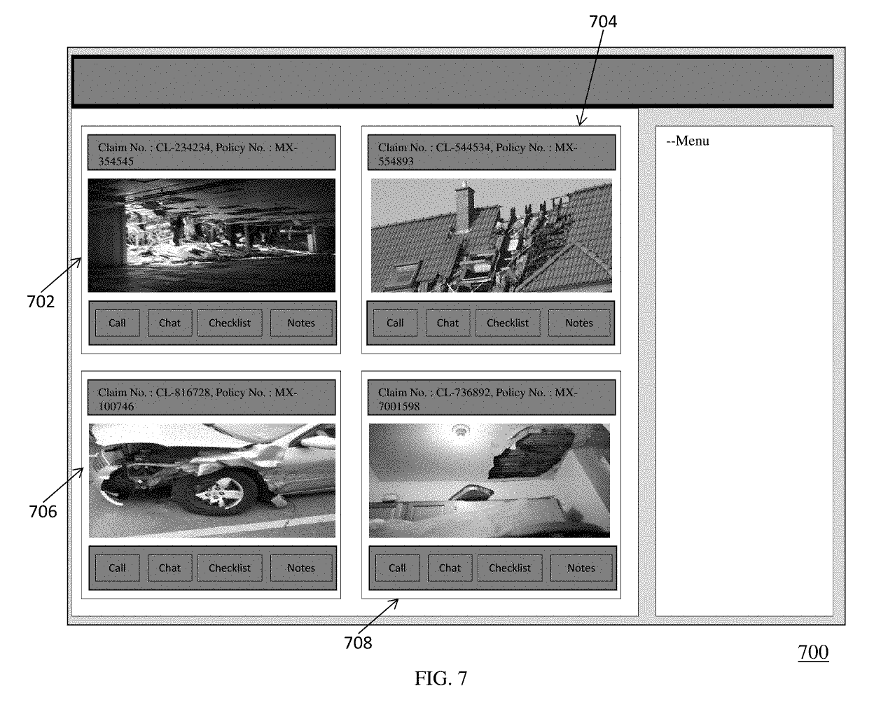

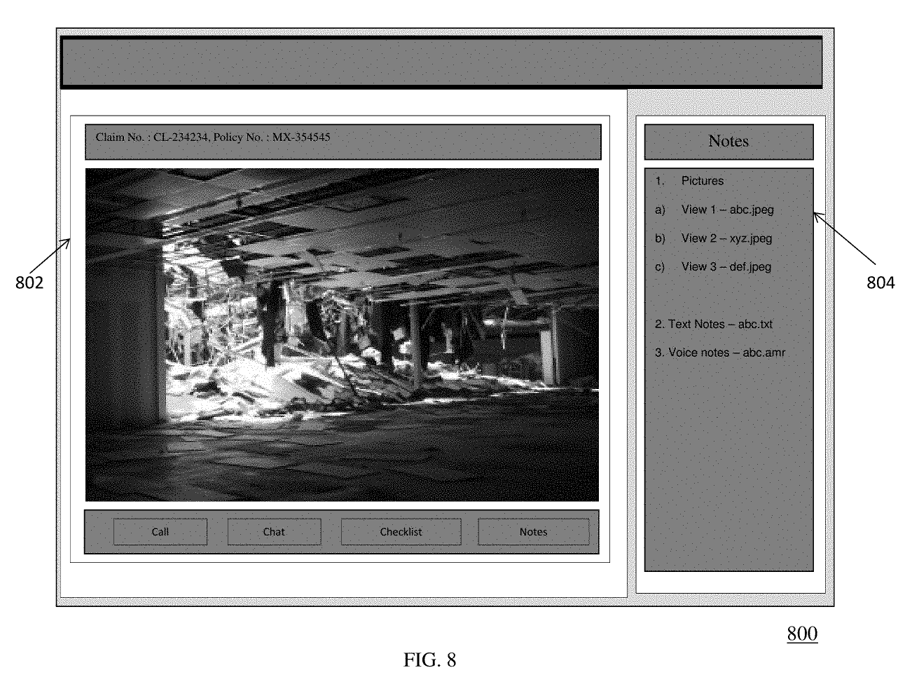

At step 610, the received one or more multimedia streams along with the other claim details are displayed at the user interface of the claim assessment device. In an embodiment of the present invention, the reception and display of the multimedia streams at the user interface initiates the multimedia conference session between the claim assessment device and each of the claim inspection systems. Further, the highly skilled insurance personnel using the claim assessment device and each of the novice personnel at the location of the claim objects exchange one or more communications during the multimedia conference session such as, but not limited to, multimedia file, checklist, etc. In an embodiment of the present invention, the layout of the user interface display of the claim assessment device is provided in real-time based on the number of the multimedia streams received at the claim assessment device. This aspect of providing the user interface display layout is explained later with respect to FIGS. 7 and 8.

At step 612, a check is performed to determine whether more details are required for claim assessment at the claim assessment device.

At step 614, an instruction for capturing/re-capturing one or more details of the claim object is transmitted, based on the determination that more details are required for assessment. The one or more instructions may be received in the form of a checklist including multiple tasks to be performed for claim inspection. For example, an instruction may be received from the claim assessment device 102 (FIG. 1) to capture a front view and a back view of the claim object. In another exemplary embodiment of the present invention, an instruction may be received for conducting inspection of an insurance claim object by capturing a first view using a device associated with the claim inspection system, and capturing a second view using another device associated with the claim inspection system.

At step 616, one or more new video stream or new claim details related to the claim object are received at the claim assessment device.

At step 618, one or more inputs are received from the highly skilled insurance personnel using the claim assessment device. The inputs are received with respect to an individual multimedia stream during the multimedia conference session between the claim assessment device and the claim inspection system.

At step 620, a detailed assessment report is generated based on the received one or more inputs from the highly skilled insurance personnel. In an embodiment of the present invention, the detailed assessment report is generated based on one or more details received from the claim inspection system during the multimedia conference session.

FIG. 7 illustrates an exemplary user interface of the claim assessment device during multimedia conference session with the claim inspection systems at the location of claim object during inspection, in accordance with an embodiment of the present invention.

The claim assessment device 102 (FIG. 1) may include a user interface 700 for displaying the multimedia streams for assessment by the highly skilled insurance personnel using the claim assessment device during the multimedia conference session. In an exemplary embodiment of the present invention, the claim assessment device may be communicating with four different claim inspection systems simultaneously. The claim assessment device receives a multimedia stream from each of the claim inspection systems 104a-104d (FIG. 1) at different locations of the claim objects. In this exemplary embodiment, the layout of the user interface may be divided automatically into four segments 702, 704, 706, and 708 to accommodate the different multimedia streams for displaying simultaneously. Further, each segment of the display corresponding to a multimedia stream may include details of the insurance claim corresponding to the multimedia stream, and a list of interaction options with the claim inspection personnel at the claim object location. The list of interaction options may include, “call”, “chat”, “checklist”, “notes”, etc. The highly skilled insurance personal at the claim assessment device may select one of the interaction options (e.g. chat) for interacting with the novice claim personnel at the claim object location.

FIG. 8 illustrates another exemplary user interface of the claim assessment device during multimedia conference session with the claim inspection systems, in accordance with an embodiment of the present invention.

In an embodiment of the present invention, the user interface is configured to receive an input from the highly skilled insurance personnel, and further configured to selecting one multimedia stream from the displayed different multimedia streams at the user interface of the claim assessment device based on the received input. Further, based on a selected multimedia stream, the user interface layout is configured to automatically re-segment itself for displaying only the selected multimedia stream 802.

In another embodiment of the present invention, the user interface is configured to receive an input from the highly skilled insurance personnel with respect to selection of an interaction option (e.g. “notes”) from the displayed list of interaction options during a multimedia conference session. Further, the user interface is configured to re-segment itself to display contents of the selected “notes” section in a separate segment 804. In an exemplary embodiment of the present invention, the selected “notes” section may include details such as different pictures (e.g. view 1, view 2, and view 3 of a claim object), text notes, voice notes, etc. which are displayed in a separate segment 804. The displayed details of the “notes” section may be received from one of the claim inspection systems during the multimedia conference session. The highly skilled insurance personnel then performs the assessment and generates a detailed report for each of the claim objects based on the details provided by the corresponding claim inspection system during the multimedia conference session.

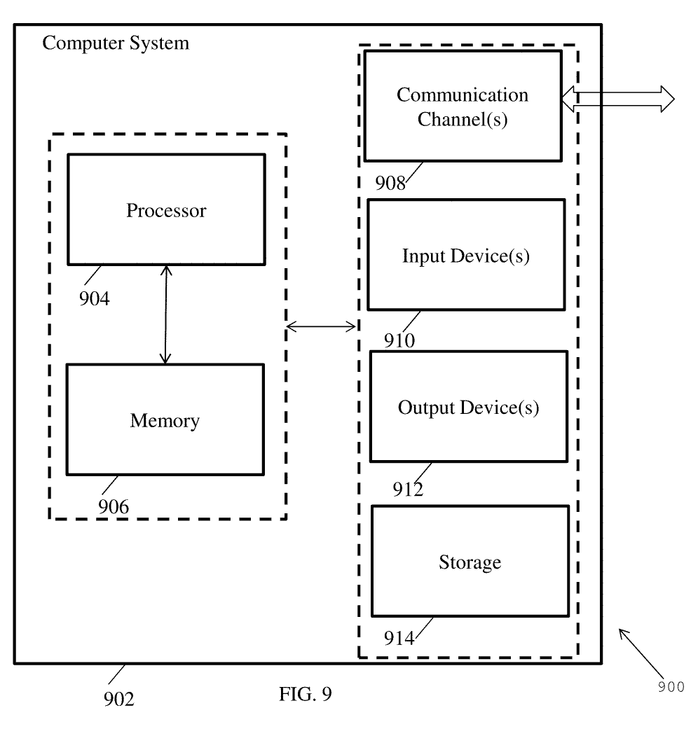

FIG. 9 illustrates an exemplary computer system in which various embodiments of the present invention may be implemented.

The computer system 902 comprises a processor 904 and a memory 906. The processor 904 executes program instructions and may be a real processor. The computer system 902 is not intended to suggest any limitation as to scope of use or functionality of described embodiments. For example, the computer system 902 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 906 may store software for implementing various embodiments of the present invention. The computer system 902 may have additional components. For example, the computer system 902 includes one or more communication channels 908, one or more input devices 910, one or more output devices 912, and storage 914. An interconnection mechanism (not shown) such as a bus, controller, or network, interconnects the components of the computer system 902. In various embodiments of the present invention, operating system software (not shown) provides an operating environment for various softwares executing in the computer system 902, and manages different functionalities of the components of the computer system 902.

The communication channel(s) 908 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 910 may include, but not limited to, a keyboard, mouse, pen, joystick, trackball, a voice device, a scanning device, or any another device that is capable of providing input to the computer system 902. In an embodiment of the present invention, the input device(s) 910 may be a sound card or similar device that accepts audio input in analog or digital form. The output device(s) 912 may include, but not limited to, a user interface on CRT or LCD, printer, speaker, CD/DVD writer, or any other device that provides output from the computer system 902.

The storage 914 may include, but not limited to, magnetic disks, magnetic tapes, CD-ROMs, CD-RWs, DVDs, flash drives or any other medium which can be used to store information and can be accessed by the computer system 902. In various embodiments of the present invention, the storage 914 contains program instructions for implementing the described embodiments.

In an embodiment of the present invention, the computer system 902 is part of a distributed network where various embodiments of the present invention are implemented for rapidly developing end-to-end software applications.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 902. The method described herein is typically implemented as a computer program product, comprising a set of program instructions which is executed by the computer system 902 or any other similar device. The set of program instructions may be a series of computer readable codes stored on a tangible medium, such as a computer readable storage medium (storage 914), for example, diskette, CD-ROM, ROM, flash drives or hard disk, or transmittable to the computer system 902, via a modem or other interface device, over either a tangible medium, including but not limited to optical or analogue communications channel(s) 908. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A centralized server for simultaneously processing data associated with multiple claim objects placed at different locations, the centralized server comprising:
a memory comprising program instructions;
a processor configured to execute program instructions stored in the memory;
an input unit in communication with the processor and configured to receive two or more insurance claims from user devices corresponding to the multiple claim objects placed at different locations;
an analyzing unit in communication with the processor and configured to:
determine one or more parameters related to the insurance claims and the multiple claim objects; and
assess capability information related to two or more claim inspection systems;
a task allotment unit in communication with the processor and configured to:
correlate the determined one or more parameters and the capability assessment information with one or more predefined rules stored in a repository; and
assign, based on the correlation, each of the received insurance claims to a different claim inspection system of the two or more claim inspection systems; and
a multimedia stream processing unit in communication with the processor and configured to:
simultaneously receive, from each of the two or more claim inspection systems, a multimedia file representing captured information related to inspection of the claim object associated with the assigned insurance claim; and
simultaneously process and transmit the received multimedia files to a claim assessment device for assessment of each of the multiple claim objects associated with the insurance claims, the claim assessment device placed at a second location, the second location being different from the location of each of the claim inspection systems.

2. The centralized server of claim 1, wherein each of the two or more claim inspection systems comprises at least one of a wearable device and an unmanned aerial vehicle.

3. The centralized server of claim 1, wherein the analyzing unit is further configured to assess capability information related to multiple claim assessment devices, and further wherein the task allotment unit is configured to assign, based on the one or more predefined rules, the received insurance claims to a claim assessment device of the multiple claim assessment devices.

4. The centralized server of claim 1, wherein the task allotment unit is further configured to transmit one or more instructions to each of the two or more claim inspection systems for conducting inspection of the multiple claim objects.

5. The centralized server of claim 4, wherein the one or more instructions comprise: conducting inspection of an insurance claim object by capturing a first view using a device associated with the two or more claim inspection systems, and capturing a second view using another device associated with the two or more claim inspection systems.

6. An electronic communication device configured to simultaneously assess data associated with multiple claim objects placed at different locations, the electronic communication device comprising:
a memory comprising program instructions; and
a processor configured to execute program instructions stored in the memory and further configured to:
receive two or more multimedia files, each of the two or more multimedia files representing captured information related to inspection of each of the multiple claim objects, the multiple claim objects being placed at different locations, wherein each multimedia file comprises a real-time first view video of each of the multiple claim objects;
simultaneously display the real-time first view video corresponding to each of the two or more multimedia files; and
generate an insurance claim assessment report corresponding to each of the two or more multimedia files based on assessment of each of the multiple claim objects.

7. The electronic communication device of claim 6, wherein the simultaneous display of the real-time first view videos is based on a predefined layout pattern corresponding to a number of the real-time first view videos.

8. The electronic communication device of claim 6, wherein the processor is further configured to transmit, in response to receiving the two or more multimedia files, at least one new instruction to two or more claim inspection systems for conducting inspection of the multiple claim objects, the at least one new instruction comprising capturing additional views of the multiple claim objects and re-capturing the real-time first view videos.

9. The electronic communication device of claim 8, wherein the processor is further configured to receive at least one new multimedia file, the at least one new multimedia file representing captured additional views of the multiple claim objects and re-captured real-time first view videos related to inspection of the multiple claim objects.

10. A method for simultaneously processing data associated with multiple claim objects placed at different locations, the method comprising:
receiving two or more insurance claims corresponding to the multiple claim objects from user devices placed at different locations;
determining one or more parameters related to the insurance claims and the multiple claim objects;
assessing capabilities of two or more claim inspection systems;
correlating the determined one or more parameters and the capability assessment information with one or more predefined rules;
assigning, based on the correlation, each of the received insurance claims to a different claim inspection system of the two or more claim inspection systems;
simultaneously receiving a multimedia file representing captured information related to inspection of the claim object associated with the assigned insurance claim;
simultaneously processing and transmitting the received multimedia files for assessment of each of the multiple claim objects associated with the insurance claims, the assessment being performed at a second location, the second location being different from the location of the multiple claim objects.

11. The method of claim 10, wherein each of the two or more claim inspection systems comprises at least one of a wearable device and an unmanned aerial vehicle.

12. The method of claim 10 further comprising:
assessing capability information related to multiple claim assessment devices; and
assigning, based on the one or more predefined rules, the received insurance claims to a claim assessment device of the multiple claim assessment devices.

13. The method of claim 10 further comprising:
transmitting one or more instructions to each of the two or more claim inspection systems for conducting inspection of the multiple claim objects.

14. The method of claim 13, wherein the one or more instructions comprise: conducting inspection of an insurance claim object by capturing a first view using a device associated with the two or more claim inspection systems, and capturing a second view using another device associated with the two or more claim inspection systems.

15. A method for simultaneously assessing of data associated with multiple claim objects placed at different locations, the method comprising:
receiving two or more multimedia files, each of the two or more multimedia files representing captured information related to inspection of each of the multiple claim objects, the multiple claim objects being placed at different locations, wherein each multimedia file comprises a real-time first view video of each of the multiple claim objects;
simultaneously displaying the real-time first view video corresponding to each of the two or more multimedia files; and
generating an insurance claim assessment report corresponding to each of the two or more multimedia files based on assessment of each of the multiple claim objects.

16. The method of claim 15, wherein the simultaneous display of the real-time first view videos is based on a predefined layout pattern corresponding to a number of the real-time first view videos.

17. The method of claim 15 further comprising:
transmitting, in response to receiving the two or more multimedia files, at least one new instruction to two or more claim inspection systems for conducting inspection of the multiple claim objects, the at least one new instruction comprising capturing additional views of the multiple claim objects and re-capturing the real-time first view videos.

18. The method of claim 15 further comprising:
receiving at least one new multimedia file, the at least one new multimedia file representing captured additional views of the multiple claim objects and re-captured real-time first view videos related to inspection of the multiple claim objects.
